(19) United States
(12) Patent Application Publication
(10) Pub. No.: US 2009/0077184 A1
(43) Pub. Date: Mar. 19, 2009

(54) Remote Control of Mobile Terminal via Remote Control Proxy and SMS

(76) Inventors: Martin John Brewer, Kirkland, WA (US); Kirk C. Salomon, Renton, WA (US)

Correspondence Address: NEWMAN & NEWMAN, ATTORNEYS AT LAW, LLP, 505 FIFTH AVENUE SOUTH, SUITE 610, SEATTLE, WA, 98104, US

(21) Appl. No.: 11/857,341

(22) Filed: Sep. 18, 2007

(51) Int. Cl. G06F 15/173; G06F 15/16

(52) U.S. Cl. 709/206; 709/223

(57) ABSTRACT

A remote operator and a mobile terminal initiate contact with a remote control proxy server. These components may be behind a firewall. If a mobile terminal does not have a then-extant session with the remote control proxy server, the remote operator and/or the remote control proxy server may send an SMS message to the mobile terminal and/or a device associated with the mobile terminal, which SMS message causes the mobile terminal to initiate a session with the remote control proxy server. After the mobile terminal and the remote operator are both connected to the remote control proxy server, the remote control proxy server passes communications between the mobile terminal and the remote operator without modification. The remote operator may control the mobile device keyboard, screen and may pass arguments to parameters associated with the operation of the device or its applications.

### BACKGROUND

Mobile terminal devices (personal digital assistants or “PDAs”, mobile bar code scanning terminals, general purpose laptop computers, transient personal computers and the like) are often used in conjunction with a wireless local area network (WLAN) or a wireless wide area network (WWAN). The terminal itself is often provisioned with operating software which includes applications which are pertinent to the job in hand. For example, it would be normal for a delivery driver to operate an application program on a PDA which would allow the operator to check on stock levels for items on the truck.

The terminal and its operating system and applications can experience operational difficulties from time to time, or may be misused due to a lack of operator training. In such circumstances it is advantageous for a remote operator (such as a help desk) to aid the operator of the device by taking remote control of the mobile terminal. In such a case the remote operator would be able to view the screen of the remote device and would have control of the mobile device's inputs (such as keyboard and/or mouse). This would allow the remote operator to be able to change, remotely, parameters concerning the operation of the device or its applications.

Typically, for a remote operator to be able to remote control a mobile terminal which is in use in the field, a TCP/IP connection is initiated from the help desk location, through a data network, to the mobile terminal. However, while this mode of operation is common and operates well over LAN environments, it can fail in environments which employ network security devices (such as firewalls) and/or environments and situations where the remote terminal device may be in a “sleep” state (that is, the device has powered off to conserve power).

The art has demonstrated use of an SMS message to initiate a remote control session of a second mobile terminal by a first terminal (mobile or stationary) through data conveyed within the SMS message, which data includes session connection parameters. See, for example, US patent publication number 20040235424, titled, “System and method for controlling a mobile terminal located remote from a user.”

See also, for example, U.S. Patent publication number 20060111131, titled, “Short message service (SMS) remote control for mobile station,” in which, “[a]n object . . . is to provide for SMS remote control for a mobile station to enable a user to check whether the SMS of the mobile station is performed normally, by controlling the SMS from a remote location, such as via the Internet.”

See also, for example, U.S. Pat. No. 6,301,484, titled, “Method and apparatus for remote activation of wireless device features using short message services (SMS),” which describes sending specifically configured SMS messages to wireless communication devices. The specifically configured SMS messages are parsed to identify a specific format which is used to convey control messages to the wireless communication device.

See also U.S. Pat. No. 7,039,708, titled, “Apparatus and method for establishing communication in a computer network,” which describes establishing communication between a first client computer in a vehicle and a remote web server or “communications controller component” by means of an SMS message. The first client computer has a component to decode SMS communications. A second client computer is configured to send instructions and requests to a servlet executing on the server/communications controller component. Following an iterative process in which the servlet sends a form for completion to the second client computer, the communications controller component is prompted to send one or more SMS messages to the first client. The first client decodes the SMS messages and extracts a URL which identifies the communications controller component and servlet, which the first client computer contacts. The servlet downloads applets to the first client computer, which applets the first client computer executes. The first client computer returns results to the communications controller component; the results are matched by session ID and sent to the second client computer for display on a browser.

The art has not demonstrated a method, system, or apparatus in which a remote operator may control a mobile terminal behind a firewall and/or under circumstances in which the mobile terminal is in a sleep state, where communication between the remote operator and the mobile terminal is through a pass-through channel provided by an intermediate server.

### SUMMARY

This summary is provided to introduce a selection of concepts in a simplified form that are further described below in the detailed description. This summary is not intended to identify key feature or essential features of the claimed subject matter, nor is it intended to be used to limit the scope of the claimed subject matter.

Generally stated, the disclosed invention is directed to a method and apparatus in which a mobile terminal may initiate a session with a remote operator, allowing the remote operator to connect with and take remote control over a mobile terminal. In one aspect of the invention the remote operator makes a direct connection with the mobile terminal via TCP/IP. In another aspect of the invention if the remote operator cannot establish a connection with the mobile terminal, it will instead initiate a connection with a remote control proxy server (“RCPS”), the RCPS will then determine if it has any pre-established sessions with the mobile terminal based on a unique identifier (“UID”). If no pre-established connection exists, the RPCS will attempt to make a direct connection with the mobile terminal via TCP/IP. This may be successful for example if the RPCS is on the same side of a firewall as the mobile terminal. If the connection is successful it will connect the remote operator to the mobile terminal. In yet another embodiment, the RPCS may be unable to make a direct connection to the mobile terminal, this may be due to the remote operator and/or the mobile terminal and/or the RCPS being behind a firewall and/or the mobile terminal may be in a sleep mode. The RCPS will send an SMS message to the mobile terminal by looking up the phone number of the device by its UID. The phone number may either be pre-configured by a remote operator or determined during a direct connection initiation. Once the mobile terminal receives the SMS message it will extract the IP address of the RCPS from the message and initiate the session with the RCPS. Once the mobile terminal connection is established the RPCS will connect the remote operator with the mobile terminal.

Without limitation, the remote operator may control the mobile device keyboard, screen and may be able to pass arguments, remotely, to parameters concerning the operation of the device or its applications and may be able to install new software and cause a restart or other re-initialization of the device memory.

### BRIEF DESCRIPTION OF THE DRAWINGS

FIG. 1 is a functional block diagram of exemplary computing devices and network connections in and through which systems and methods consistent with the principals of the invention may be implemented.

FIG. 2 depicts an operational flow diagram generally illustrating steps consistent with certain aspects of the invention.

FIG. 3 is a message diagram between certain components consistent with certain aspects of the invention.

FIG. 4 is a functional block diagram of an exemplary computing device that may be used to implement one or more embodiments of components of the invention.

### DETAILED DESCRIPTION

The following detailed description refers to the accompanying drawings. The same reference numbers in different drawings identify the same or similar elements. The following detailed description is for the purpose of illustrating embodiments of the invention only, and other embodiments are possible without deviating from the spirit and scope of the invention, which is limited only by the appended claims. Certain of the figures are labeled with terms associated with specific software applications or categories of software applications, such as “browser,” “webserver,” or “db,” which is an abbreviation of “database.” The labels and the following discussion use these terms and related terms such as “website” as examples and not as limitations. Equivalent functions may be provided by other software applications operating on general and/or specialty purpose computing devices. Thus, references in this document to a browser, a webserver, or a database should be understood to describe any software application providing similar functions, operating on suitable hardware for such software application, and provided with suitable communication facilities. Except as otherwise noted, references to a “network” shall be understood to describe any suitable network capable of providing communication between the other components, such as but not limited to the Internet. The components depicted in the figures represent function groups; it should be understood that such function groupings need not exist as discrete hardware devices or software applications and that the functions described as occurring within, comprising, or being provided by a grouping may be provided within or by common or separate physical and/or logical hardware devices and software applications. The components within and comprising any of the function groupings may be regrouped in other combinations and certain of the functions may be omitted without deviating from the spirit of the disclosed invention.

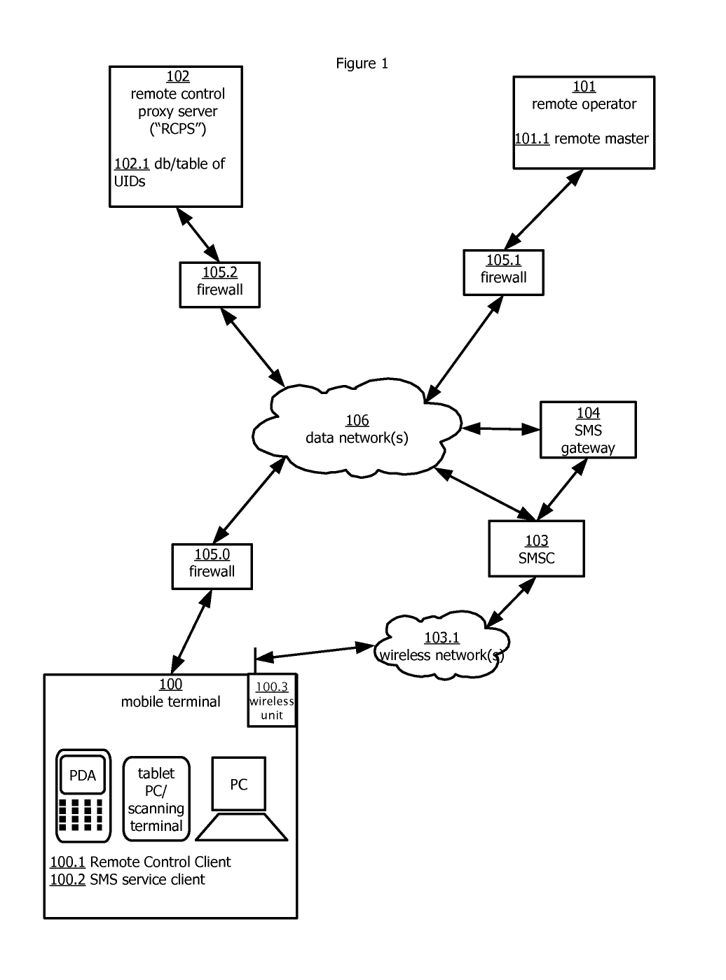

Turning now to the figures, FIG. 1 depicts a mobile terminal 100 in communication with a remote operator 101, a RCPS 102, an SMSC 103 and/or an SMS gateway 104, through one or more firewalls 105.0, 105.1, and 105.2 and via one or more data networks 106. Examples of computing devices which may be a mobile terminal are depicted in FIG. 1 and include, without limitation, a PDA, mobile bar code scanning terminal, a mobile general purpose computer (such as a tablet or laptop computer, which are equivalent for the purposes of this disclosure), and/or a transient personal computer. These examples should not be understood to limit the definition of mobile terminal. The mobile terminal is further depicted as comprising a remote control client 100.1 (described further below), an SMS client 100.2 and a wireless unit 100.3. The firewalls 105.0, 105.1, and 105.2 depicted between the mobile terminal 100, the RCPS 102, the remote operator 101 and the data network 106 may be part of the operating system and/or application software on such devices or they may be provided by separate hardware and/or software. Firewalls 105 are generally well known in the art, comprising stateful and stateless network, packet, and application layer filters, with and without use of a proxy device or network address translation.

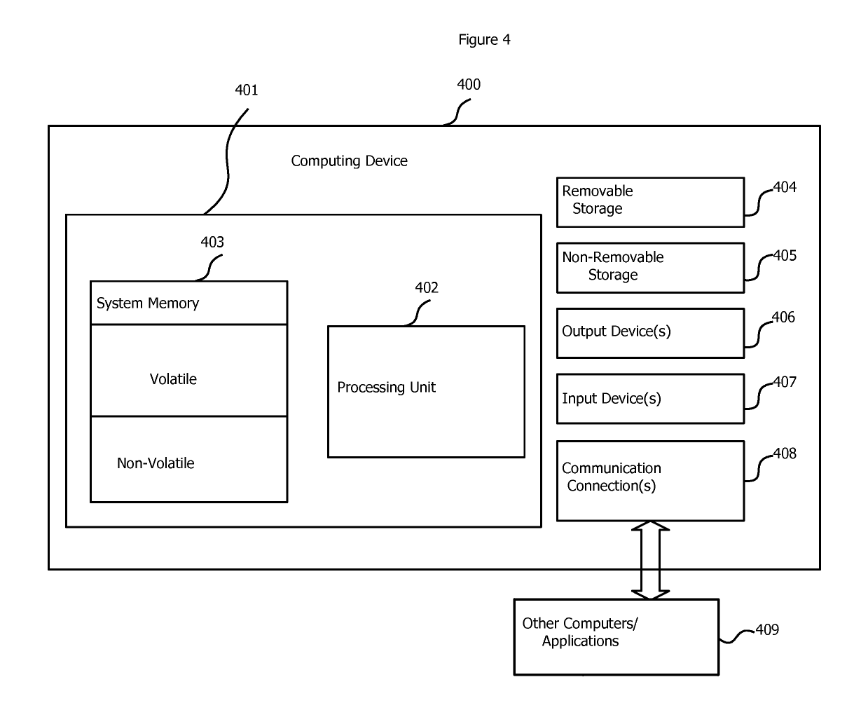

The SMS service client 100.2 is a software application which allows a computer to send and receive SMS messages according to at least the SMS protocol, if not also the EMS (“enhanced message service”) and/or MMS (“multimedia message service”) protocols, and may also control associated communication equipment such as, in this example, the wireless unit 100.3, and/or a network card (not shown in FIG. 1, see FIG. 4, feature 408). References herein to SMS messages should be understood to include SMS, EMS, and/or MMS messages. The SMS client 100.2 is able to inspect all or at least a portion of inbound SMS messages, evaluate them according to various criteria, such as the message source and/or the text and/or binary content of the message packet(s), and to execute certain instructions in response thereto, such as, for example, to wake the mobile terminal 100 and/or to wake and/or initiate other processes executed by the mobile terminal 100, such as the remote control client 100.1 and/or to pass messages and/or portions of messages to such processes. The SMS client 100.2 is also further capable of staying in an active state regardless if the mobile terminal is in a sleep mode. The SMS client 100.2 may be provided as part of the wireless unit 100.3. The wireless unit 100.3 may be provided if the mobile terminal 100 is to communicate with the SMS gateway 103 using wireless media, such as radio frequency electromagnetic radiation. The wireless unit 100.3 may comprise a wireless telephone with SMS capability. Alternatively, the mobile terminal may use and/or may be replaced by a network card for communication with the data network(s) 106. The wireless unit 100.3 may be a separate unit connected to the mobile terminal 100 or may be incorporated into the mobile terminal 100. Not shown are other operating system and application software components which may be present and which are known in the art.

The SMSC 103 is an SMS service center or equivalent. Generally, SMSC's route and store SMS messages sent to and/or from mobile phones and other devices in mobile telephone networks. SMSC's may perform other functions, such as batch processing of SMS messages and billing for use of SMS services. SMSC's are often part of and/or provide services to and/or through mobile telephone and other wireless networks 103.1. SMS gateways 104 perform similar functions, though generally with respect to communications which originate and/or terminate with a device other than a mobile phone, such as services which provide email/voicemail/browser input to SMS and visa versa. The SMS gateway 104 may be connected to and/or may be part of an SMSC 103 and/or may communicate with a wireless network 103.1.

Also depicted in FIG. 1 is the RCPS 102. The RCPS 102 is the system through which the mobile terminal 100 and the remote operator 101 connect. The RCPS 102 receives one or more inbound TCP/IP or similar connection requests from the remote control client 100.1 executing on one or more mobile terminals 100, which connection requests comprise the IP address allocated to the mobile terminal 100 and a UID for the mobile terminal 100. The UID may be based, for example, on a combination and/or concatenation of device parameters which do not or are slow to change, such as a MAC and IP address of the primary interface, an operating system UID, and similar. If a mobile terminal looses a UID and/or a UID expires or otherwise is no longer current, the UID may be re-issued and/or a new UID may be generated. The connection may utilize the HTTP and/or HTTPS protocols over TCP/IP and/or XML or another markup language over TCP/IP (references herein to “XML” should be understood to include the extensible markup language or other similar markup languages). The RCPS 102 may authenticate the connection request and/or the mobile terminal 100 and may further authorize the mobile terminal 100 relative to the services provided by the RCPS 102. Authentication and authorization may be performed in one of many ways known in the art, such as through exchange of one or more public key(s), comparison of public key(s) to one or more private key(s), and lookup of an authenticated user in a table of user authorization privileges.

The RCPS 102 holds open the connections it has with the remote operator 101 and/or the mobile terminal 100, taking IP data from each and passing the data from one connection to the other, without use of a routing table and without changing the routing used by either the remote operator 101 and/or the mobile terminal. After the remote operator 101 and the mobile terminal 100 are (as necessary) authenticated and authorized with respect to the RCPS's services and a pass-through connection is established between the remote operator 101 and the mobile terminal 100, the RCPS 102 does not interpret, act upon, or transform the data passing between the remote operator 101 and the mobile terminal 100 through the RCPS 102.

Similar to the description above, with respect to connection requests from mobile terminals 100, a remote operator 101 wishing to connect with a mobile terminal 100 establishes a TCP/IP or similar connection with the RCPS 102. The connection may utilize the HTTP and/or HTTPS protocols and/or XML over TCP/IP. The RCPS 102 may authenticate the connection and/or the remote operator 101 and may further authorize the remote operator 101 relative to the services provided by the RCPS 102. The connection and/or a subsequent communication within the connection may identify the mobile terminal with which the remote operator 101 wishes to connect. Identification of the mobile terminal may be through use of a unique or other form of identifier which has previously been assigned to and/or created by the mobile terminal and which is known or made known to the RCPS 102, such as during registration of the remote control client 100.1 with the RCPS 102. If the RCPS 102 has an existing connection with the mobile terminal 100 identified by the remote operator 101, then the RCPS 102 facilitates a connection between the mobile terminal 100 and the remote operator 101 as described above.

The RCPS 102 and the remote operator 101 may be provided by applications executing on the same computer hardware and/or on different computers, remote from one another.

Also depicted in FIG. 1 is a remote operator 101. The remote operator 101 may comprise a general purpose computing system, similar to that shown in FIG. 4. The computing system provided for the remote operator 101 must at least be sufficient to allow the remote operator 101 to emulate and/or to provide a visualization of and/or to otherwise display or output the output from one or more mobile terminals 100, to receive input from an operator of the remote operator 101, and to send at least some of such input to the one or more mobile terminals 100, as described further below. The remote operator 101 may be provided with an application, such as the remote master 101.1, to provide these functions.

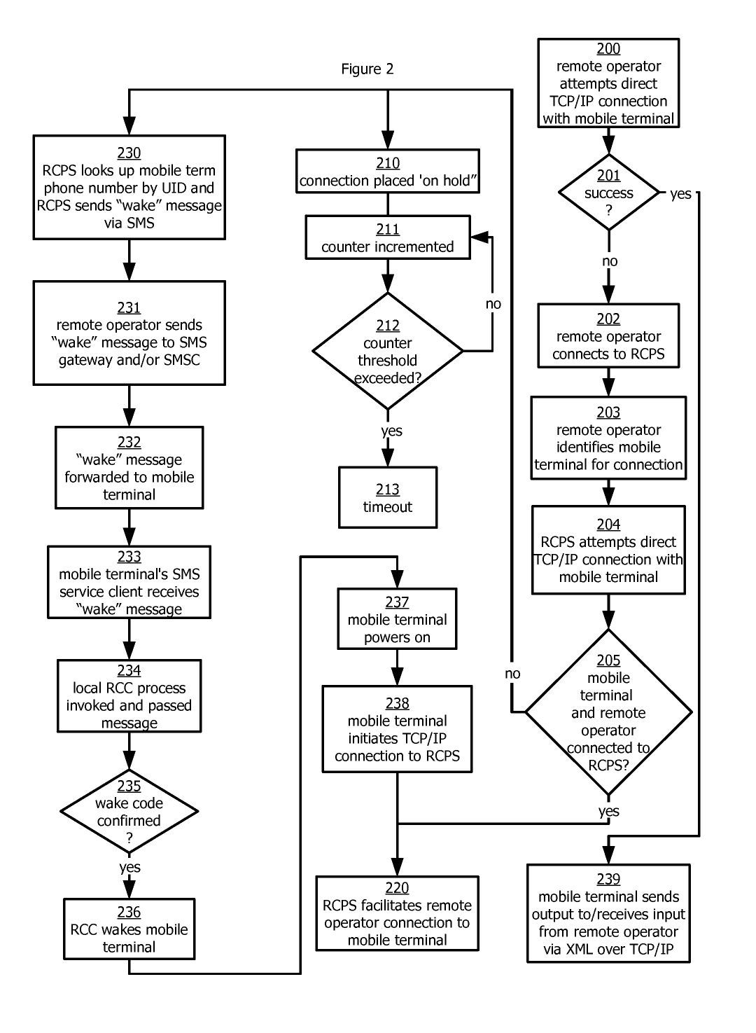

FIG. 2 depicts an operational flow diagram generally illustrating steps consistent with certain aspects of the invention. At step 200, the remote operator 101 and/or the remote master 101.1 may attempt to directly connect with the mobile terminal 100. As indicated above, the connection may utilize the HTTP and/or HTTPS protocols over TCP/IP and/or XML over TCP/IP. At step 201, the remote operator 101 and/or the remote master 101.1 may evaluate whether the attempted connection at step 200 was successful, such as might be possible if the devices are on the same side of a firewall. If the attempted connection at step 200 is successful, the *** If the attempted connection at step 200 is not successful, the remote operator 101 may connect to the RCPS 102 at step 202. As indicated above, the connection may utilize the HTTP and/or HTTPS protocols over TCP/IP and/or XML over TCP/IP. The remote operator 101 may be authenticated and authorized by and/or with respect to the RCPS 102 (authentication steps not shown).

At step 203, the remote operator 101 identifies the mobile terminal 100 with which it wishes to communicate, such as might be possible if the devices are on the same side of a firewall. As indicated elsewhere, identification of the mobile terminal 100 may be through use of a unique or other form of identifier which has previously been assigned to and/or created by the mobile terminal 100. The identifier is known or made known to the RCPS 102, such as during registration of the remote control client 100.1 with the RCPS 102, and/or to the remote operator. A database of registered mobile terminals 102.1 may contain, for example, UID's, IP address(es), telephone number(s), authentication credentials of or for mobile terminals, the time (including last time) the mobile terminal was contacted, current session state (connected, disconnected, pending, suspended, failed, and similar) and the last error.

At step 204, the RCPS 102 attempts a direct connection with the mobile terminal 100. At decision junction step 205, the RCPS 102 determines if the identified mobile terminal 100 and the remote operator 101 both have a connection to the RCPS 102. If the answer at this decision junction is affirmative, then the process proceeds to step 220, where the RCPS 102 facilitates a connection between the remote operator 101 and the mobile terminal 100 as described above. If the answer at decision junction 205 is negative, then two separate but related processes begin, the process beginning with step 210 and the process beginning with the step 230. If the answer at decision junction 205 is negative, the RCPS 102 may inform the remote operator 101 that the mobile terminal is not connected to the RCPS 102.

At step 210, the connection from the remote operator 101 is placed on hold, meaning that the connection is not terminated, but neither is it necessarily used. Either the remote operator 101 and/or the RCPS 102 may terminate the connection. At step 211, a counter or similar process located at either the remote operator 101 and/or the RCPS 102 is incremented and/or initiated. The counter may be incremented upon the occurrence of an external event, such as the passage of time, upon invocation of the incrementing step 211, and/or upon the occurrence of other events. The counter may be a clock. At step 212, a decision junction is evaluated by the remote operator 101 and/or the RCPS 102 to determine if the counter threshold has been exceeded. If the counter threshold has not been exceeded, then the process returns to step 211. If the counter threshold has been exceeded, then the process proceeds to the timeout step 213, which step may further comprise (not shown) i) actively terminating the connection between the RCPS 102 and the remote operator 101 and/or the mobile terminal 100 or ii) not renewing the connection prior to its scheduled termination.

At step 231, the remote operator 101 and/or the RCPS 102 sends a wake message to the mobile terminal 100. The wake message may be sent first to an SMSC 103 and/or an SMS gateway 104. The wake message may be sent as an SMS message. If sent to an SMS gateway 104, the wake message may be sent as an email, such as an SMTP email, the SMS gateway being configured to generate an SMS, EMS, and/or MMS message in response to receipt of emails. The SMS gateway 104 may then forward the generated SMS, EMS, and/or MMS message to an SMS service center (“SMSC”) 103 which would generally route the wake message through available wireless networks 103.1, though wireline transmission is also possible. The wake message includes a wake code, such as a character string, number, and/or binary string. The wake code is included in the packet or packets which comprise the SMS, EMS, and/or MMS message. The SMS service client 100.2 forwards the wake message to other processes, such as the remote control client 100.1. The wake message may be sent, for example and without limitation, with delivery confirmation as provided in the SMS protocol.

The wake message may be received by the wireless unit 100.3 and SMS client 100.2 which are generally part of and/or in close proximity to and/or in communication with the mobile terminal 100. Step 233 depicts receipt of the wake message by the mobile terminal's SMS service client 100.2. As discussed elsewhere, the mobile terminal's wireless unit 100.3 and SMS service client 100.2 may be processes which continue regardless of whether or not the mobile terminal is in a “sleep” (powered down) mode.

Upon receipt of the wake message at step 233, the mobile terminal SMS service client 100.2 utilizes a registered filter or similar to determine that the wake message contains a wake code and is to be used by and/or forwarded to a local destination or process such as the remote control client 100.1. The SMS and similar protocols (EMS, MMS) provide packets of a certain size and/or structure, various components of which packets may be parsed and/or otherwise passed to other processes and/or which may form arguments for parameters in the mobile terminal SMS service client application 100.2. If the received message is not a wake message (not shown), the mobile terminal SMS service client 100.2 may store the message for later use and/or viewing and/or process the non-wake message according to other stored procedures. Receipt of a message, whether or not a wake message, may result in a responsive message (not shown) to the SMSC 103 and/or the SMS gateway 104 to confirm receipt of the message.

At optional decision junction 235, the remote control client 100.1 and/or the mobile terminal SMS service client 100.2 may determine whether or not the wake message contains a proper wake code. If the wake message does not contain a proper wake code, the remote control client 100.1 may, for example, send a notification message to this effect to the remote operator 101 and/or the RCPS 102 and/or another party (not shown).

If at decision junction 235, the remote control client 100.1 and/or the mobile terminal SMS service client 100.2 confirms that the wake message contains a proper wake code and/or if the remote control client 100.1 is merely invoked and passed the wake message without confirmation, the remote control client 100.1 may wake the mobile terminal 100 as depicted at step 236, if the mobile terminal 100 is not already awake. The mobile terminal 100 may then power up 237 and be directed by the remote control client 100.1 to initiate a TCP/IP connection to the RCPS 102. If the remote operator 101 is also still connected and still has a then-current request still pending to connect with the mobile terminal 100, then the RCPS 102 may then facilitate a connection between the mobile terminal 100 and the remote operator 101.

The TCP/IP connection between the mobile terminal 100, the remote operator 101, and the RCPS 102 may be setup in a three-way or other handshake as are well known in the art with respect to TCP/IP connections. The TCP/IP connections may be terminated by the mobile terminal 100, the remote operator 101, and/or the RCPS 102 in a four- or three-way termination handshake or equivalent, as are well known in the art with respect to TCP/IP connections. Connections may be left half-open, wherein one host has terminated but the other has not. For example, the remote operator 101 may terminate a connection, whereupon the RCPS's 102 connection with the remote operator 101 may be placed in a suspended state, while the RCPS's 102 connection with the mobile terminal 100 remains open. Applications executing on the mobile terminal 100 and the remote operator 101, such as the remote control client 100.1, may then connect using, for example, an Internet socket wherein the remote IP address and port is that of the RCPS 102 and wherein the RCPS 102 is configured to pass received packets from the mobile terminal 100 to the remote operator 101 and visa versa.

Significantly, each of the mobile terminal 100 and the remote operator 101 initiate a connection with the RCPS 102. Each such device may then communicate with the RCPS 102 and, through the RCPS 102, with each other, regardless of the presence of one or more firewalls 105.0 through 105.2 and without the need for either the mobile terminal 100 and/or the remote operator 101 to act as a server.

Using XML over TCP/IP, the mobile terminal 100 may transmit the current screen, audio, and other output to the remote operator 101, step 239 in FIG. 2. The remote operator 101 may receive this information from the mobile terminal 100 via the RCPS 102 and/or through a direct connection. The remote master 101.1 may render some or all of this information as output local to the remote operator 101, such as in an application shell or window provided at the remote operator 101 for this purpose. The remote operator 101 and/or remote control master 101.1 may then return keyboard, mouse and/or other input to the mobile terminal 100 via the RCPS 102 and/or through a direct connection, which input may be received, for example, by the remote control client 100.1 and passed, as appropriate, as arguments to the operating system and application program parameters and/or as data to be stored in memory. In an alternative embodiment, the exchange of output from the mobile terminal 100 and the input from the remote operator 101 may utilize XML over UDP/IP in conjunction with techniques to provide error correction and/or data redundancy to address, as desired, the lack of native error correction in the UDP protocol.

Upon establishing a connection between the remote operator 101 and the mobile terminal 100 through the RCPS 102, the remote operator 101 may then substitute the remote operator's input for that of input which may be provided locally to the mobile terminal 100. The remote operator 101 may control the initialization, execution, and termination of application programs and processes, including the ability to update and otherwise change the operating system and, as may be necessary, to restart and/or reinitialize the mobile terminal and/or particular processes (with appropriate instructions left in memory to re-initiate the mobile terminal's connection with the RCPS 102 upon restart).

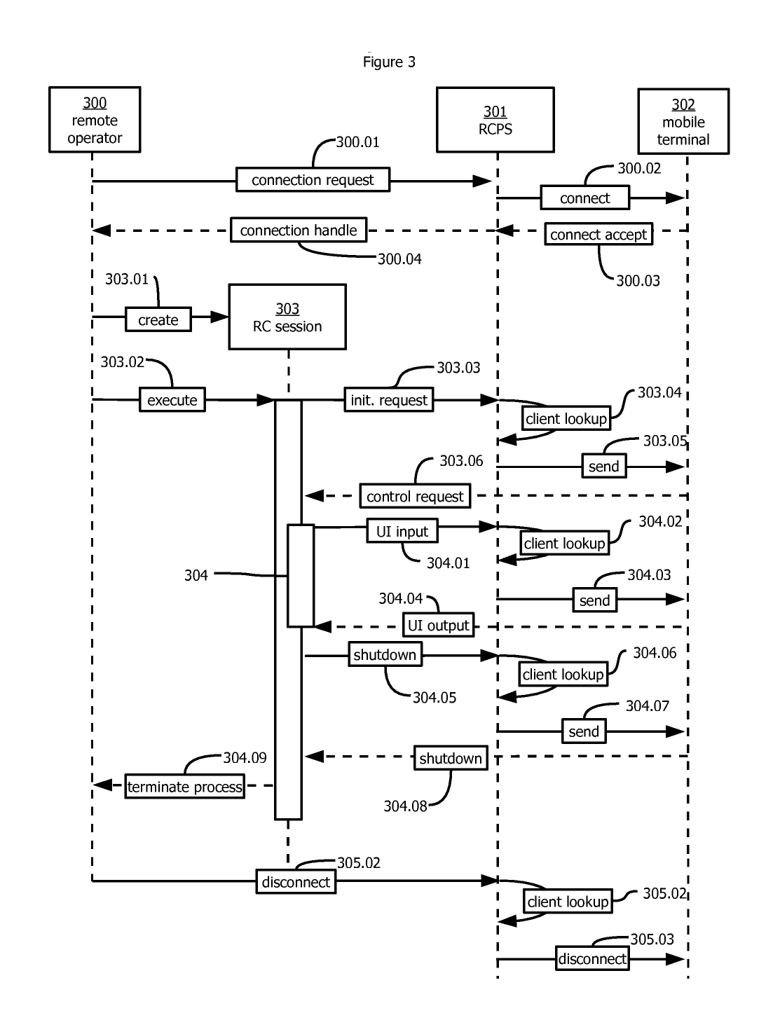

FIG. 3 is a message diagram depicting message flow between a remote operator 300, the RCPS 301, and a mobile terminal 302. The message diagram is a simplification provided as an example. This message diagram does not show the steps from FIG. 2 relating to contacting the mobile terminal 302 via SMS with a wake message. The message diagram assumes that the RCPS 301 is able to contact the mobile terminal 302, such as for example, following transmission of a wake message as described above. The message diagram depicts TCP/IP connection requests 300.01 and 300.02 by the remote operator 200 and the RCPS, connection acceptance 300.03 by the mobile terminal, and a connection handle 300.04 passing from the RCPS 301 to the remote operator 300. The message diagram then depicts the remote operator 300 creating 303.01 a remote control session process 303, through which the remote operator 300 will be able to control the mobile terminal 302. Following step 303.01, the remote operator 300 begins execution 303.02 of the remote control session process 303 with an remote control session initialization request 303.03 which is sent to the RCPS 301. The RCPS 301 is depicted performing a client lookup 303.04 and then sending 303.05 the initialization request to the mobile terminal 302. The mobile terminal 302 responds with a control request 303.06 which is relayed by the RCPS 301 to the remote operator's remote control session process 303.

The remote control session then becomes active at step 304, as user interface output is sent 304.04 by the mobile terminal 302, as user interface input is sent 304.01 by the remote operator, and as the RCPS 301 performs a client loopup 304.02 and relays 304.03 the UI input from the remote operator 300 to the mobile terminal 302.

At step 304.05, the remote operator's remote control session process 303 sends a shutdown command 304.05. The RCPS 301 performs a client lookup 304.06, and relays 304.07 the shutdown command to the mobile terminal 302. The mobile terminal 302 responds with a shutdown command and/or acknowledgment 304.08 which is relayed by the RCPS 301 to the remote control session process 303 at the remote operator 300. The remote control session process 303 sends any termination messages 304.09 to the remote operator 300. The remote operator then sends a TCP/IP disconnect message 305.02 to the RCPS 301, which RCPS 301 may then perform a client lookup 305.02 and which RCPS 301 may then send a TCP/IP disconnect message 305.03 to the mobile terminal 302. In other embodiments, the TCP/IP connections may be left open and other messages may be sent.

Computing device 400 includes one or more communication connections 408 that allow computing device 400 to communicate with one or more computers and/or applications 409. Device 400 may also have input device(s) 407 such as a keyboard, mouse, digitizer or other touch-input device, voice input device, etc. Output device(s) 406 such as a monitor, speakers, printer and other types of digital display devices may also be included. Removable and non-removable storage may be provided such as at 404 and 405. A system bus may be provided, such as at 401, to provide communication between the other components of the computing device 400. These devices are well known in the art and need not be discussed at length here. The remote operator 101, RCPS 102, and mobile terminal 100 may be provided by a computing device 400.

1. A method to connect a mobile terminal and a remote operator through a remote control proxy server comprising the following steps, not necessarily in the following order:
the remote operator connecting with a remote control proxy server;
the remote operator identifying a mobile terminal with which it wishes to establish a remote connection;
the remote control proxy server passing data between the remote operator and an identified mobile terminal;
sending a wake message to the identified mobile terminal;
the mobile terminal connecting with the remote control proxy server.

2. The method according to claim 1 where the connections between the remote operator and the remote control proxy server and between the mobile terminal and the remote control proxy server are TCP/IP connections.

3. The method according to claim 2 where the TCP/IP connections transport data formatted according to XML.

4. The method according to claim 1 where the data comprises user interface output from the mobile terminal and user input from the remote operator.

5. The method according to claim 1 where the wake message is sent in at least a portion of its transmission path to the mobile terminal as a message in a protocol selected from the SMS, EMS, and/or MMS message protocols.

6. The method according to claim 1 where the wake message is sent as an email to an SMS gateway and/or an SMSC, which SMS gateway and/or SMSC may convert the email into a and transmit the message according to a protocol selected from the SMS, EMS, and/or MMS message protocols.

7. The method according to claim 1 where the wake message comprises a wake code.

8. The method according to claim 1 further comprising execution of a remote control client application in the computer system of the mobile terminal, which remote control client application:
monitors a wireless unit for receipt of a wake message,
prompts the mobile terminal to power up if the mobile terminal was in a low-power mode,
transmits output from the mobile terminal,
receives input from the remote operator, and
provides the input from the remote operator to the computer system of the mobile terminal.

9. A system to connect a remote operator and a mobile terminal comprising the following:
a remote control proxy server component configured to:
connect with a remote operator and/or a mobile terminal,
pass data between a remote operator and/or a mobile terminal,
send a wake message if a mobile terminal is not connected to the remote control proxy server when a remote operator has requested to relay data to the mobile terminal through the remote control proxy server.

10. The system according to claim 9 further comprising:
a remote operator component configured to:
establish a connection with a remote control proxy server, and
receive output from and provide input to a mobile terminal via the remote control proxy server.

11. The system according to claim 9 further comprising:
a mobile terminal component configured to:
establish a connection with a remote control proxy server,
provide output to and receive input from a remote operator via the remote control proxy server,
power up in response to receipt of a wake message.

12. The system according to claim 9 wherein the connection with a remote operator and/or a mobile terminal is a TCP/IP connection.

13. The system according to claim 9 wherein the data is formatted according to a markup language.

14. The system according to claim 9 wherein the remote control proxy server is further configured to send the wake message in at least a portion of its transmission path to the mobile terminal as a message in a protocol selected from the SMS, EMS, and/or MMS message protocols.

15. The system according to claim 9 wherein the remote control proxy server is further configured to send the wake message as an email to an SMS gateway and/or an SMSC, which SMS gateway and/or SMSC may convert the email into a and transmit the message according to a protocol selected from the SMS, EMS, and/or MMS message protocols.

16. A computer-readable medium containing instructions for controlling a computer system to transmit data between a remote operator and a mobile terminal by a method comprising, not necessarily in the following order:
connecting with a remote operator and/or a mobile terminal,
passing the data between a remote operator and a mobile terminal,
sending a wake message to a mobile terminal if:
such mobile terminal is not connected to the computer system, and if a remote operator connected to such computer system requests a remote connection with such mobile terminal.

17. The computer-readable medium according to claim 16 wherein the wake message is sent in at least a portion of its transmission path to the mobile terminal as a message in a protocol selected from the SMS, EMS, and/or MMS message protocols.

18. The computer-readable medium according to claim 16 wherein the data is formatted according to XML.

19. The computer-readable medium according to claim 16 wherein connecting with a remote operator and/or a mobile terminal is connecting with a TCP/IP connection.

20. The computer-readable medium according to claim 16 wherein the wake message is sent as an SMTP email to an SMS gateway and/or an SMSC.
